(19) United States
(12) Patent Application Publication
(10) Pub. No.: US 2003/0164366 A1
(43) Pub. Date: Sep. 4, 2003

(54) Method of bonding a heating element to a glass or glass-ceramic material

(75) Inventors: Christiane Baum, Louisville, KY (US); Theodore A. Wegert, Louisville, KY (US)

Correspondence Address: VOLPE AND KOENIG, P.C., UNITED PLAZA, SUITE 1600, 30 SOUTH 17TH STREET, PHILADELPHIA, PA, 19103, US

(73) Assignee: Schott Glas, Mainz (DE)

(21) Appl. No.: 10/295,751

(22) Filed: Nov. 15, 2002

Related U.S. Application Data
(60) Provisional application No. 60/334,832, filed on Nov. 15, 2001.

(51) Int. Cl. B32B 31/00; H05B 3/74

(52) U.S. Cl. 219/467.1; 156/280; 219/465.1

(57) ABSTRACT

A method of bonding a heating element onto the back of a glass or glass-ceramic material is provided. The heating element is bonded to the back of the glass or glass-ceramic material using a suitable adhesive material, such as an adhesive tape, RTV silicone, or a similar temperature resistant, chemically inert material. A burner unit formed from a glass or glass-ceramic material having a desired shape with the heating element connected to it with a heat resistant adhesive can be formed by this method. This allows greater freedom of design of burners to have any desired shape, as well as providing a strong, easily cleanable surface.

### CROSS-REFERENCE TO RELATED APPLICATIONS

This application claims the benefit of U.S. Provisional Application No. 60/334,832, filed Nov. 15, 2001, which is incorporated by reference herein as if fully set forth.

### BACKGROUND

The present invention is directed to a method of bonding a heating element to a glass or glass-ceramic material, and to a novel burner unit made by this method.

The currently used heating elements for home products, such as household electric ranges, are generally high cost, have a fixed shape and may not pass the UL Ball Drop Test in accordance with UL 858 “Household Electric Ranges”. This results in higher costs in producing electric ranges, as well as shorter service life due to damage.

It would be desirable to provide an improved heating element and method of assembly which reduces costs, allows more flexibility in design, and will pass the UL Ball Drop Test.

### SUMMARY

Briefly stated, the present invention provides a method of bonding a heating element onto the back of a glass, glass-ceramic material or other suitable material, for example, as used in connection with a range top. The heating element is bonded to the back of the material using a suitable adhesive material, such as an adhesive tape, RTV and/or heat cured RTV, or a similar temperature resistant, chemically inert material.

In another aspect, the invention provides a burner unit formed from a glass or glass-ceramic material having a desired shape, and a heating element connected to the glass or glass-ceramic material with a heat resistant adhesive. This allows greater freedom of design of burners to have any desired shape, as well as providing a strong, easily cleanable surface.

### BRIEF DESCRIPTION OF THE DRAWING(S)

The foregoing summary, as well as the following detailed description of the preferred embodiments of the invention will be better understood when read in conjunction with the appended drawings. For the purpose of illustrating the invention, there are shown in the drawings embodiments which are presently preferred. It should be understood, however, that the invention is not limited to the precise arrangements shown.

FIG. 1 is a perspective view of a heating element which is installed in accordance with the present invention; and

FIG. 2 is a side view showing the heating element installed on the backside of a glass or glass-ceramic material.

### DETAILED DESCRIPTION OF THE PREFERRED EMBODIMENT(S)

Certain terminology is used in the following description for convenience only and is not considered limiting. The terms “a” and “one” are defined as including one or more of the referenced item unless specifically noted. Those skilled in the art will recognize that the invention is not limited to the preferred embodiment described below, but encompasses other applications within the spirit and scope of the present invention.

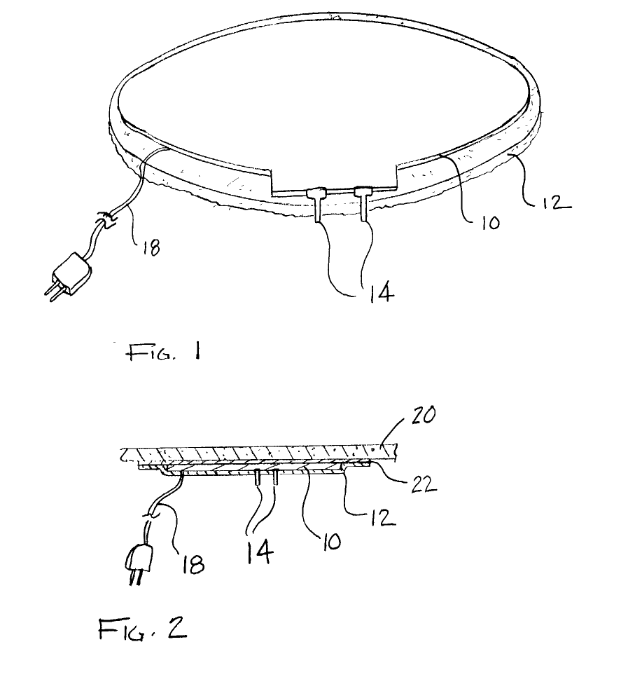

Referring to FIG. 1, a heating element 10, which can be used for example for a warming zone of a range top or for a burner formed of a glass or glass-ceramic material, is shown. The heating element 10 may have an insulating material 12 over the bottom portion. However, this is not required. Electrodes 14 are connected to the heating element 10 for supplying power to the heating element 10, and a connection 18 for a temperature sensor may also be provided. The heating element 10 can be, for example, a foil heating element or elements located within a carrier material. Those skilled in the art will recognize that any other suitable heating element could also be used.

Referring to FIG. 2, the heating element 10 is bonded on the backside of a glass, glass-ceramic or other suitable material 20, such as a range top or a burner sized and shaped part, utilizing an adhesive material 22, which could be for instance an adhesive tape, RTV silicone, heat cured RTV or any other suitable temperature resistant and chemically inert material. RTV silicone is preferred as the adhesive material 22 since it is commonly used in the assembly of ranges and could also be used as an insulator if the backside of the heating element 10 is coated with an appropriate layer of RTV silicone. Alternatively, separate insulation 12, which may be formed of a suitable ceramic-fiber material may be added or bonded on the backside of the heating element 10.

The material 20 can have any desired shape, so that individual burner units are formed, or may be part of a larger surface having a specific zone or individual zones that can be heated to act as warming or cooking areas.

If necessary, devices for switching, adjusting and/or controlling the temperature of the heating element can be internally embedded or externally connected to the heating element 10.

In accordance with the present invention, a heating element 10 which can be easily installed, and which is very thin and can be bonded on the backside of a glass or glass-ceramic material 20 is provided, allowing further freedom in the size and design of ranges or other heated articles. While it is preferred that the heating element 10 be insulated, it is not required. Alternatively, this type of adhesive application can also be used to bond heating elements to other suitable substrates for other heating applications, and is not limited for use with ranges or stove tops, and the substrate is not limited to glass or glass-ceramic materials.

While the preferred embodiments of the invention have been described in detail, the invention is not limited to the specific embodiments described above, which should be considered as merely exemplary. Further modifications and extensions of the present invention may be developed, and all such modifications are deemed to be within the scope of the present invention as defined by the appended claims.

What is claimed is:

1. A method of affixing a heating element to a substrate, comprising:
applying a heat resistant adhesive material to a surface of a heating element; and
affixing the adhesive coated heating element to a backside of a substrate.

2. The method of claim 1, further comprising applying an insulating layer over the heating element.

3. The method of claim 1, wherein the substrate is a glass or glass-ceramic material.

4. The method of claim 3, wherein the glass-ceramic material and heating element affixed thereto form a burner unit for a range top.

5. The method of claim 4, wherein the glass or glass-ceramic material of the burner unit can be shaped to any desired configuration.

6. A burner unit, comprising:
a glass or glass-ceramic material layer having a desired shape;
a heating element affixed to the glass or glass-ceramic material with a heat resistant adhesive material.

7. The burner unit of claim 6, wherein the glass or glass-ceramic material comprises a range top.

8. The burner unit of claim 6, wherein the shape of the glass or glass-ceramic material is defined to fit in an opening of a range top or support.

9. The burner unit of claim 6, wherein an insulating layer is affixed over the heating element.
